(19) United States
(12) Patent Application Publication
(10) Pub. No.: US 2025/0303584 A1
(43) Pub. Date: Oct. 2, 2025

(54) VACUUMIZING ASSEMBLY AND VACUUMIZING DEVICE WITH REPLACEABLE VACUUMIZING ASSEMBLY

(71) Applicant: Chiun Mai Communication Systems, Inc., New Taipei (TW)

(72) Inventors: YUAN-YI LAI, New Taipei (TW); HUNG-HSIN KUO, New Taipei (TW); HAO-CHENG CHAN, New Taipei (TW); CHIEN-MING KO, New Taipei (TW); TUNG-CHUN Hsieh, New Taipei (TW); CHIH-WEI LI, New Taipei (TW); ZHEN-XIAN WU, New Taipei (TW); CHUNG-WEI WU, New Taipei (TW); CHIA-YI LIN, New Taipei (TW)

(21) Appl. No.: 19/094,262

(22) Filed: Mar. 28, 2025

(30) Foreign Application Priority Data
Mar. 29, 2024 (TW) 113112237
Mar. 29, 2024 (TW) 113112238

(51) Int. Cl. B25J 15/06; B25J 15/04; B25J 19/00; B25J 19/02

(52) U.S. Cl. CPC B25J 15/0616; B25J 15/045; B25J 19/0091; B25J 19/02

(57) ABSTRACT

The present application discloses a vacuumizing assembly and a vacuumizing device with replaceable vacuumizing assembly. The vacuumizing assembly includes a suction nozzle, and the suction nozzle includes a mesh portion, a connecting portion, a telescopic portion, and a detection component. The mesh portion is disposed on a first end of the suction nozzle, the connecting portion is disposed on a second end of the suction nozzle. The telescopic portion can extend or contract between the first end and the second end, the inner side of the extensible portion and the inner side of the connecting portion form a hollow pipeline. The detection component is used to detect whether the extensible portion has preset deformation. The present application can detect whether it should change the suction nozzle automatically to improve efficiency of the vacuumizing device.

### CROSS-REFERENCE TO RELATED APPLICATIONS

The present application claims the benefit of and priority to Taiwan patent application NO. 113112237, field on Mar. 29, 2024, and Taiwan patent application NO. 113112238, field on Mar. 29, 2024, the entirety of which is incorporated herein by reference.

### FIELD

The present application relates to the field of automation technology, in particular to a vacuumizing assembly with detection function and a vacuumizing device with replaceable vacuumizing assembly.

### BACKGROUND

In the process of resource recovery, a system for picking and placing object usually uses a robotic arm to move the suction nozzle to pick up the object. In the resource recovery line, there are a lot of impurities in addition to the objects that can be recovered, and these impurities will lead to clogging of the suction nozzles or broken suction nozzles, and it is necessary to manually clean or replace the damaged suction nozzles.

Therefore, improvement is desired.

### BRIEF DESCRIPTION OF THE DRAWINGS

Implementations of the present application will now be described, by way of embodiments, with reference to the attached figures.

FIG. 1 is a schematic diagram of a vacuumizing assembly of an embodiment of the present application.

FIG. 2 is a schematic diagram of a vacuumizing assembly of another embodiment of the present application.

FIG. 3 is a cross-sectional view along direction III-III of FIG. 2.

FIG. 4 is a schematic diagram of a vacuumizing device of an embodiment of the present application.

FIG. 5 is a disassembled schematic diagram of a vacuumizing device of an embodiment of the present application.

FIG. 6 is a schematic diagram of the vacuumizing assembly of an embodiment of the present application.

FIG. 7 is a schematic diagram of another view of the vacuumizing assembly of an embodiment of the present application.

FIG. 8 is a schematic diagram of a supporting member of FIG. 5.

FIG. 9 is a schematic diagram of another view of a supporting member of FIG. 5.

FIG. 10 is a schematic diagram of a supporting member coupled to a connecting portion.

FIG. 11 is a disassembled schematic diagram of a trachea, a fixing structure, and an elastic element.

FIG. 12 is an assembly diagram of the trachea, the fixing structure, and the elastic element.

FIG. 13 is another schematic diagram of the vacuumizing device of an embodiment of the present application.

FIG. 14 is a block diagram of a system for picking and placing objects of an embodiment of the present application.

FIG. 15 is a schematic diagram of the system for picking and placing objects provided in an embodiment of the present application for replacing the suction nozzle.

FIG. 16 is a flowchart of a method for picking and placing objects of an embodiment of the present application.

### DETAILED DESCRIPTION

In the embodiment of the present application, the words “first” and “second” are only used to distinguish different objects and cannot be understood as indicating or implying relative importance, or as indicating or implying order. For example, the first application and the second application are used to distinguish different applications, not to describe the specific order of applications.

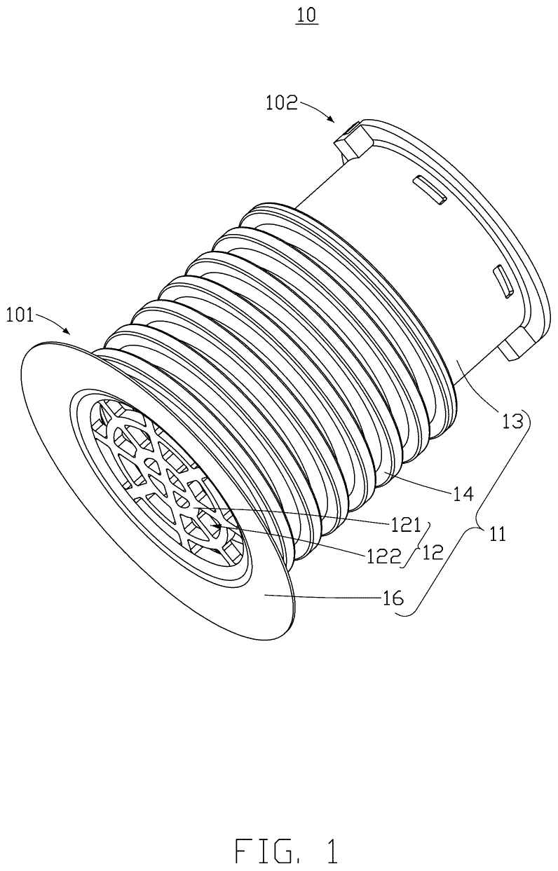

FIG. 1 illustrates a vacuumizing assembly 10 in accordance with an embodiment of the present application.

The vacuumizing assembly 10 can be applied in a vacuumizing device.

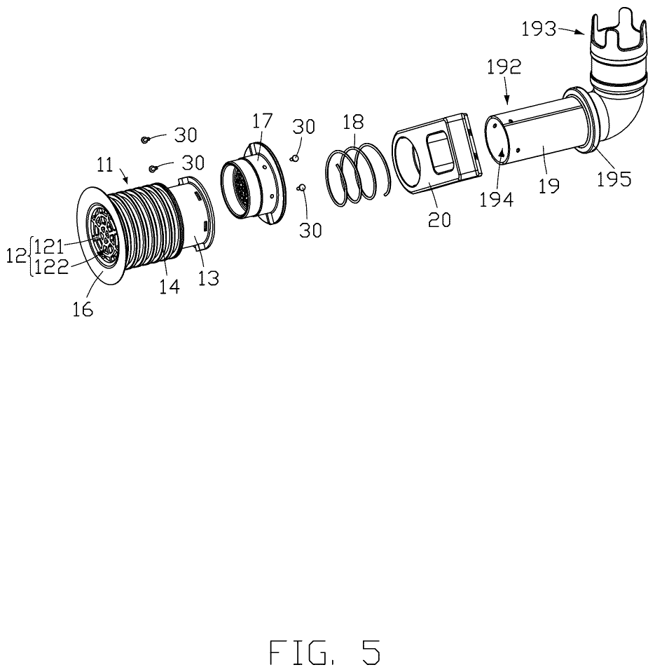

As shown in FIG. 1, the vacuumizing assembly 10 may include a suction nozzle 11. The suction nozzle 11 may include a mesh portion 12, a connecting portion 13, and a telescopic portion 14. The mesh portion 12 is disposed at a first end 101 of the suction nozzle 11, and the connecting portion 13 is disposed at a second end 102 of the suction nozzle 11. The first end 101 of the suction nozzle 11 is disposed opposite to the second end 102 of the suction nozzle 11. The telescopic portion 14 is disposed between the first end 101 and the second end 102. The telescopic portion 14 is used to extend or contract between the first end 101 and the second end 102. Both the telescopic portion 14 and the connecting portion 13 are hollow structures, such that an inner side of the telescopic portion 14 and an inner side of the connecting portion 13 can form a hollow pipe of the suction nozzle 11 (such as a hollow pipe 15 illustrated in FIG. 5). In one embodiment, the first end 101 can be used as the end from which the suction nozzle 11 picks up the object.

In one embodiment, the suction nozzle 11 can be a rubber nozzle. Optionally, the suction nozzle 11 can be made of a highly elastic polymer material with reversible deformation.

In a specific application scenario, the vacuumizing assembly 10 of the present application can be applied in a system for picking and placing object. The system for picking and placing object can pick up the objects through suction nozzle 11. The mesh portion 12 can be used to filter the objects into the suction nozzle 11. The mesh portion 12 can also be used to filter impurities into the suction nozzle 11, so that large impurities (such as plastic bags, iron caps, and paper scraps) are not sucked into the interior of the suction nozzle 11, thereby preventing blockage of the suction nozzle 11.

When the suction nozzle 11 picks up an object, the mesh portion 12 of the suction nozzle 11 will be pressed against the object for suction, and the mesh portion 12 will form a pressure on the telescopic portion 14, causing the telescopic portion 14 to contract between the first end 101 and the second end 102. When no external force is applied to the telescopic portion 14, the telescopic portion 14 can extend between the first end 101 and the second end 102. Therefore, due to the telescopic property of the telescopic portion 14, the first end 101 and the second end 102 of the suction nozzle 11 can have a telescopic amount, which not only facilitates a more powerful suction of the object, but also buffers the suction nozzle 11 from greater impact force, thereby extending the service life of the suction nozzle 11.

In one embodiment of the present application, the suction nozzle 11 can include a detection component, and the detection component is used to detect whether the telescopic portion 14 has preset deformation. For example, when the suction nozzle 11 has sucked an object, due to the vacuum effect, the telescopic portion 14 will have a telescopic amount between the first end 101 and the second end 102, the detection component can detect that the telescopic portion 14 has a preset deformation and output a detection signal to the system for picking and placing object. In other words, the system for picking and placing object can detect whether the telescopic portion 14 has a preset deformation through the detection component to determine whether the suction nozzle 11 has sucked up the object, thereby solving the problem of the prior art in which it is not possible to accurately detect whether the suction nozzle 11 has sucked up the object.

In one embodiment of the present application, the detection component can be a flexible pressure sensor.

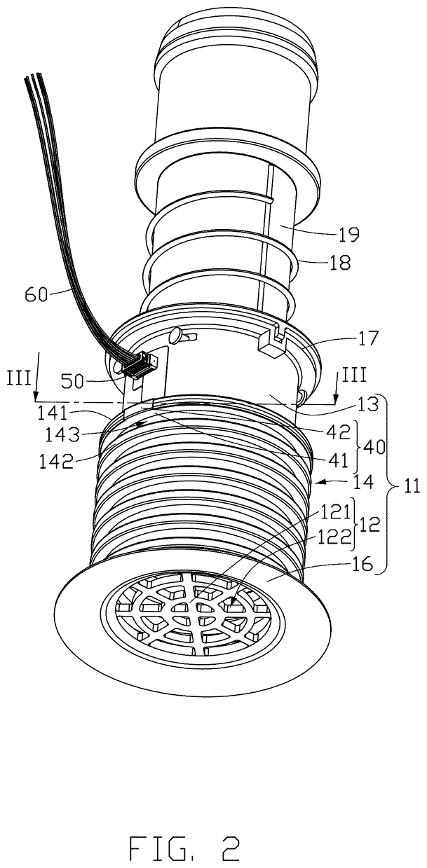

As shown in FIG. 2, in one embodiment of the present application, the suction nozzle 11 can include a flexible pressure sensor 40. More specifically, the flexible pressure sensor 40 can be disposed at the telescopic portion 14. The flexible pressure sensor 40 can include a sensing portion 41 and a conduction portion 42.

The telescopic portion 14 can also include a plurality of flanges, the plurality of flanges can surround an outer side of the telescopic portion 14, and a concave portion can be formed between two adjacent flanges. In other words, a plurality of concave portions can be disposed on the outer side of the telescopic portion 14. For example, as shown in FIG. 2, the telescopic portion 14 can include a first flange 141 and a second flange 142, and both the first flange 141 and the second flange 142 can surround the outer side of the telescopic portion 14. The first flange 141 is a flange disposed closest to the connecting portion 13, and the second flange 142 is a flange adjacent to the first flange 141. A concave portion 143 is formed between the adjacent first flange 141 and the second flange 142.

More specifically, the sensing portion 41 can be an annular sensing portion. The sensing portion 41 can be sleeved onto any one of a plurality of concave portions of the telescopic portion 14. For example, the sensing portion 41 can be sleeved onto the concave portion 143 of the telescopic portion 14.

In a possible scenario, when the vacuumizing assembly 10 uses the suction nozzle 11 to suck up an object and the suction nozzle 11 has sucked the object, due to the vacuum state inside the suction nozzle 11, the telescopic portion 14 of the suction nozzle 11 can be completely contracted, the first flange 141 and the second flange 142 will respectively squeeze the upper and lower surfaces of the sensing portion 41, so that the sensing portion 41 can sense the suction pressure of the suction nozzle 11 and the compression time sensed during contraction.

When the vacuumizing assembly 10 has sucked an object using the suction nozzle 11, the sensing portion 41 can sense that the telescopic portion 14 has a preset deformation. When the suction nozzle 11 does not suck up an object, or when the suction nozzle 11 is in a non-vacuum state inside the suction nozzle 11 due to breakage, the sensing portion 41 senses that the telescopic portion 14 does not have the preset deformation. In other words, the sensing portion 41 may utilize suction pressure and perform pressure detection by using a resistive conversion potential method. Therefore, the vacuumizing assembly 10 of the present application can detect whether the telescopic portion 14 of the suction nozzle 11 has a preset deformation through a flexible pressure sensor 40, thereby determining whether the suction nozzle 11 has suck up an object.

In one embodiment, the vacuumizing assembly 10 can further include a connector 50 and a transmission cable 60.

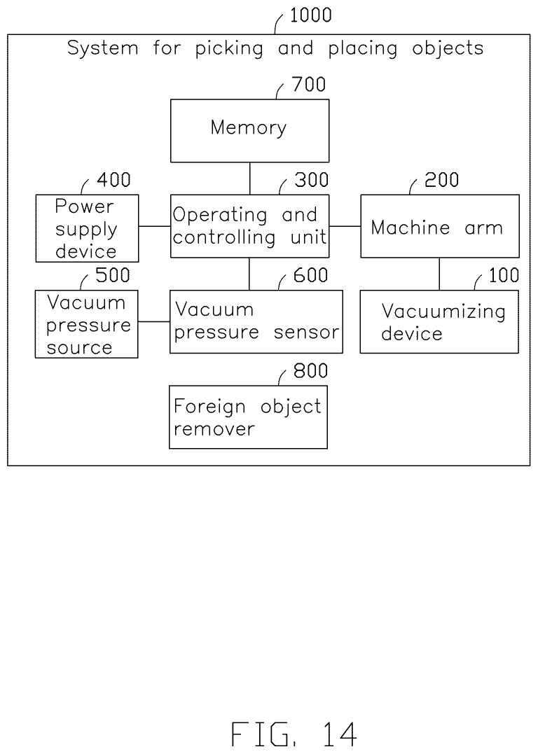

One end of the conduction portion 42 is electrically connected to the sensing portion 41, and another end of the conduction portion 42 is electrically connected to the connector 50. The connector 50 is electrically connected to an operating and controlling unit (the operating and controlling unit 300 shown in FIG. 14) of the system for picking and placing object through the transmission cable 60. In other words, the sensing portion 41 can transmit a detection result of whether the telescopic portion 14 has a preset deformation to the operating and controlling unit 300 through the conduction portion 42, the connector 50, and the transmission cable 60, so that the operating and controlling unit 300 can determine whether the suction nozzle 11 has sucked the object. It can be understood that in one embodiment, the connector 50 can be, but is not limited to, a WTB connector.

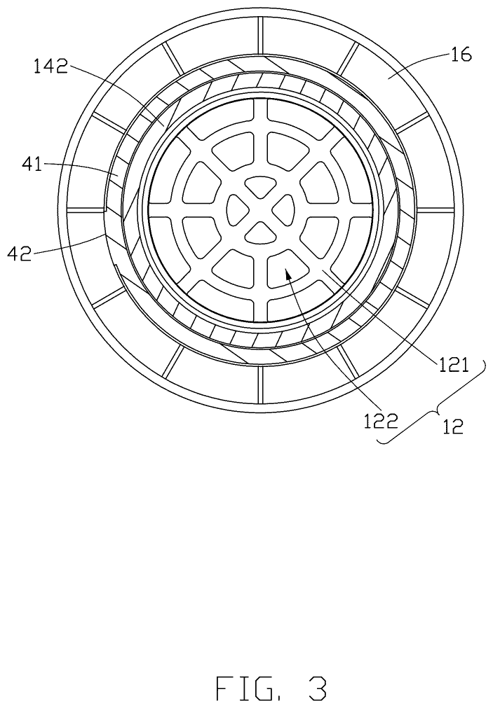

Referring to FIG. 3, the sensing portion 41 can be an annular sensing portion, and an inner diameter of the sensing portion 41 can be the same as an inner diameter of the concave portion 143 of the telescopic portion 14. Therefore, the sensing portion 41 can be sleeved onto the concave portion 143 of the telescopic portion 14 and can closely adhere to the concave portion 143 of the telescopic portion 14, which can improve the accuracy of the sensing portion 41 in detecting deformation of the telescopic portion 14. The inner diameter of the sensing portion 41 can also be the same as the inner diameter of other concave portions of the telescopic portion 14, so that the sensing portion 41 can be sleeved onto other concave portions of the telescopic portion 14 and closely adhere to other concave portions of the telescopic portion 14.

In another embodiment, the detection component can also be an image detector (such as a camera). In other words, the present application can also use the image detector to determine whether the telescopic portion 14 has a preset deformation, to determine whether the suction nozzle 11 has sucked up the object. In one scenario, the plurality of flanges on the outer side of the telescopic portion 14 may be provided with identifiers, and the image detector can determine whether the telescopic portion 14 has a preset deformation by photographing or sensing position movement of the identifiers on the plurality of flanges. For example, the first flange 141 is provided with a first identifier, and the second flange 142 is provided with a second identifier. The image detector can determine whether the telescopic portion 14 has a preset deformation by photographing or sensing the position movement between the first identifier and the second identifier. In other words, the image detector can detect whether the telescopic portion 14 has a preset deformation and send a detection result to the operating and controlling unit 300, and the operating and controlling unit 300 can determine whether the suction nozzle 11 has sucked up the object according to the detection result.

Referring to FIG. 2, in one embodiment of the present application, the vacuumizing assembly 10 can further include a supporting member 17, an elastic element 18, and a trachea 19.

The supporting member 17 is connected to the suction nozzle 11 and the trachea 19. The supporting member 17 can be used to provide support for the vacuumizing assembly 10 when picking up the objects and can make the connection between the suction nozzle 11 and the trachea 19 more secure. More specifically, the supporting member 17 can be made of metal or phenol formaldehyde plastic. More specifically, the connecting portion 13 of the suction nozzle 11 may be sleeved onto the supporting member 17, and the trachea 19 can be detachably connected to the supporting member 17. Therefore, the trachea 19 is connected to the suction nozzle 11 through the supporting member 17.

In one embodiment, the trachea 19 is also connected to a vacuum pressure source 500 (as shown in FIG. 14). Optionally, the trachea 19 is in an L-shape. The inner side of the trachea 19 is provided with a pipeline (e.g., the pipeline 194 shown in FIG. 5), and the pipeline 194 of the trachea 19 is communicated with the hollow pipe 15 of the suction nozzle 11, and the vacuum pressure source 500 can be used to realize the vacuum extraction and release through the pipeline 194 and the hollow pipe 15, to realize picking and placing of the object.

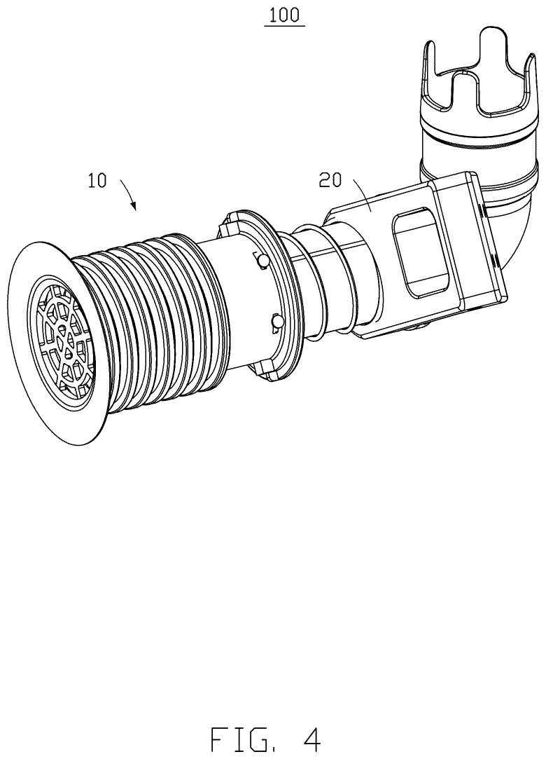

FIG. 4 and FIG. 5 illustrate a vacuumizing device 100 in accordance with an embodiment of the present application.

The vacuumizing device 100 is a replaceable vacuumizing device. The vacuumizing device 100 can be applied to a system for picking and placing objects 1000 (as shown in FIG. 14, hereinafter “the system 1000”). That is, the system 1000 can pick and place the objects through the vacuumizing device 100.

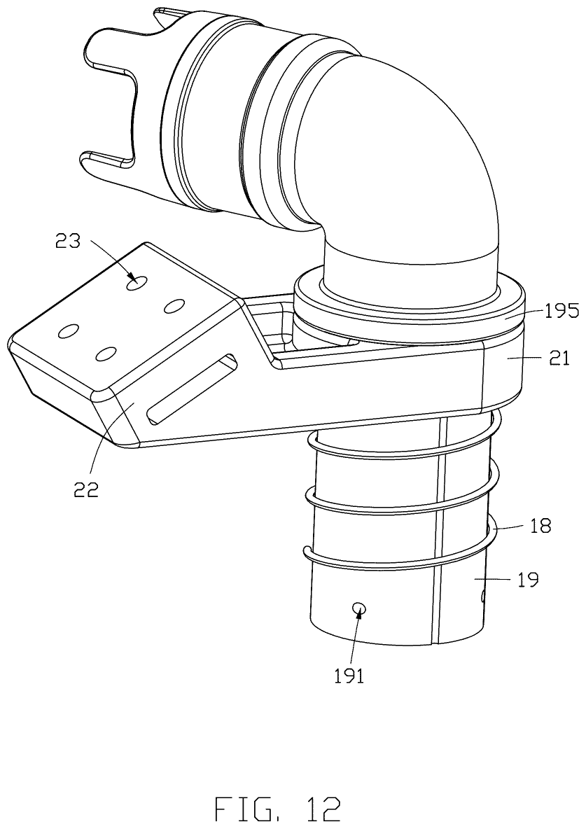

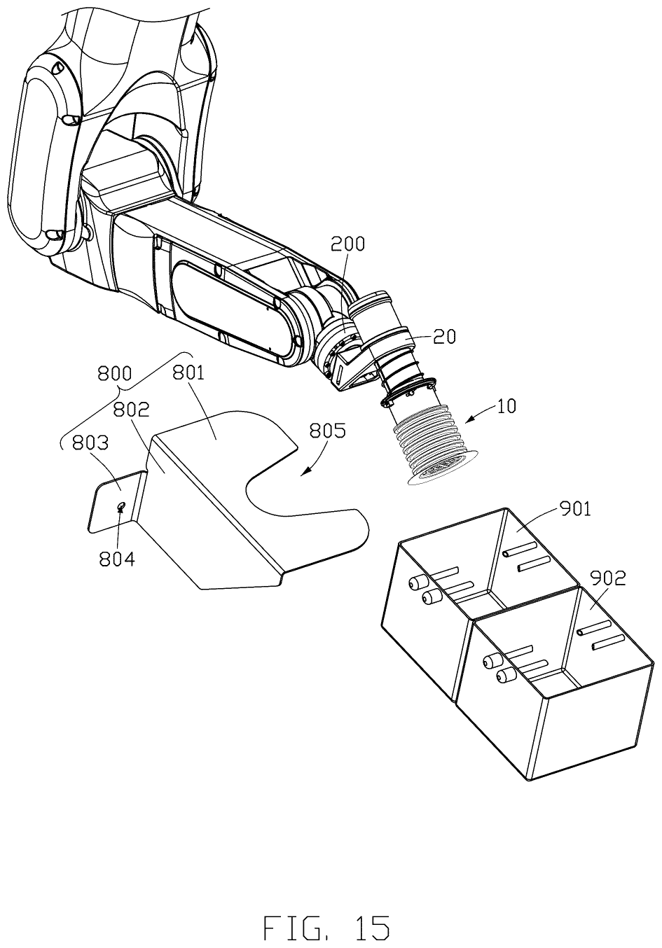

The vacuumizing device 100 can include a vacuumizing assembly 10 and a fixing structure 20. One end of the fixing structure 20 is sleeved with the vacuumizing assembly 10, and another end of the fixing structure 20 can be detachably connected to the machine arm 200 (as shown in FIGS. 12 and 15). That is, the vacuumizing assembly 10 is connected to the machine arm 200 (as shown in FIGS. 12 and 15) through the fixing structure 20. Therefore, when the machine arm 200 is moved, the machine arm 200 can move the vacuumizing device 100 together, so that the vacuumizing device 100 can realize the suction of the object at a specific position.

In one embodiment, the mesh portion 12 can be used to filter the object, and the structure of the mesh portion 12 can also provide some support. As shown in FIG. 5, the outer edge of the mesh portion 12 has a circular shape, and the middle position of the mesh portion 12 has a supporting structure 121 composed of a strip or cross shape and a concentric ring shape, and a plurality of mesh holes 122 in between the supporting structure 121. In one embodiment, the supporting structure 121 can change the spacing between concentric rings according to the size and material of the object, thereby changing the size of the plurality of mesh holes 122. In another embodiment, the cross shape of the middle position of the mesh portion 12 can also be changed to more strips, which together with the concentric ring shape form the supporting structure 121, so that the number of the mesh holes 122 increases, resulting in an increase in the density of the mesh portion 12 and a smaller aperture diameter of the mesh portion 12. The present application can control the size of large impurities blocked by changing the aperture of the mesh portion 12. The cover body portion 16 can surround the first end 101 of suction nozzle 11 and the cover body portion 16 can extend outward from the first end 101 of the suction nozzle 11. When the first end 101 of the suction nozzle 11 sucks the object, the cover body portion 16 can adhere to a surface of the object, thereby increasing the adsorption area of the suction nozzle 11 and increasing the adsorption force on the object. In addition, the cover body portion 16 also has a curvature that allows the cover body portion 16 to achieve a better adsorption effect when adhering to an object. In one embodiment, the mesh portion 12 and the cover body portion 16 are made of same material, the mesh portion 12 and the cover body portion 16 can be integrally formed, and the mesh portion 12 and the cover body portion 16 only have different thicknesses.

In one embodiment, the mesh portion 12, the telescopic portion 14, and the cover body portion 16 can be integrally formed. The mesh portion 12, the telescopic portion 14, and the cover body portion 16 are made of same material, for example, the mesh portion 12, the telescopic portion 14, and the cover body portion 16 can all be made of high elastic polymer material. The thickness of the cover body portion 16 is relatively thin, while the thickness of the mesh portion 12 is relatively thick. In other words, the thickness of the mesh portion 12 is thicker compared to the thickness of the cover body portion 16 to form a better support, so that it is not easy to be deformed and the hardness is more rigid, so that it can form a better suction nozzle performance, and it can support the overall structure of the vacuumizing device, and the cover body portion 16 can increase the adsorption area.

Referring to FIGS. 1 to 7, the connecting portion 13 of suction nozzle 11 is connected to the supporting member 17. The connecting portion 13 includes a base portion 131 and a first step portion 138. The base portion 131 of the connecting portion 13 is fixedly connected between the telescopic portion 14 and the first step portion 138 of the connecting portion 13, thereby realizing a fixed connection between the telescopic portion 14 and the connecting portion 13. The first step portion 138 of the connecting portion 13 defines at least one notch 137, and the notch 137 is used for clamping with the supporting member 17. The first step portion 138 of the connecting portion 13 can surround the second end 102 of the suction nozzle 11 and extend outward from the second end 102 of the suction nozzle 11.

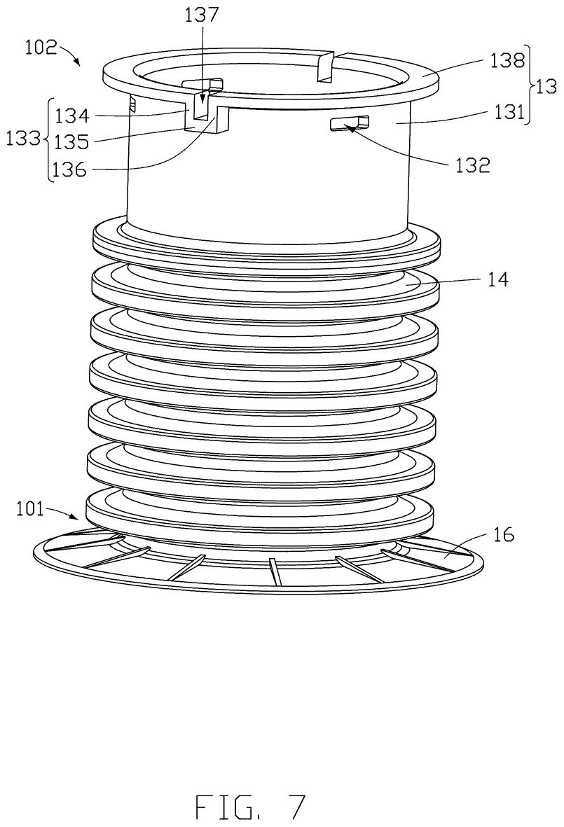

One side of the first step portion 138 near the telescopic portion 14 extends toward the first end 101 to form at least one receiving portion 133, and the receiving portions 133 corresponds one-to-one with the notches 137. The number of the receiving portions 133 can be set according to actual needs. FIG. 7 illustrates two receiving portions 133 as an example. As shown in FIG. 7, the receiving portion 133 includes a first connecting section 134, a second connecting section 135, and a third connecting section 136. A first end of the first connecting section 134 is fixedly connected to the first step portion 138, a second end of the first connecting section 134 is fixedly connected to a first end of the second connecting section 135, a second end of the second connecting section 135 is fixedly connected to a second end of the third connecting section 136, and a first end of the third connecting section 136 is fixedly connected to the first step portion 138. The notch 137 is formed between the first connecting section 134, the second connecting section 135, the third connecting section 136, and the first step portion 138. In one embodiment, the first connecting section 134 and the third connecting section 136 can be disposed in parallel, the second end of the first connecting section 134 can be vertically connected to the first end of the second connecting section 135, and the second end of the second connecting section 135 can be vertically connected to the second end of the third connecting section 136.

The base portion 131 defines at least one first through hole 132, the number of first through holes 132 can be set according to actual needs. This embodiment takes four first through holes 132 as examples for explanation. The connecting portion 13 is fixedly connected to the supporting member 17 and the trachea 19 through the first through hole 132 set on the base portion 131.

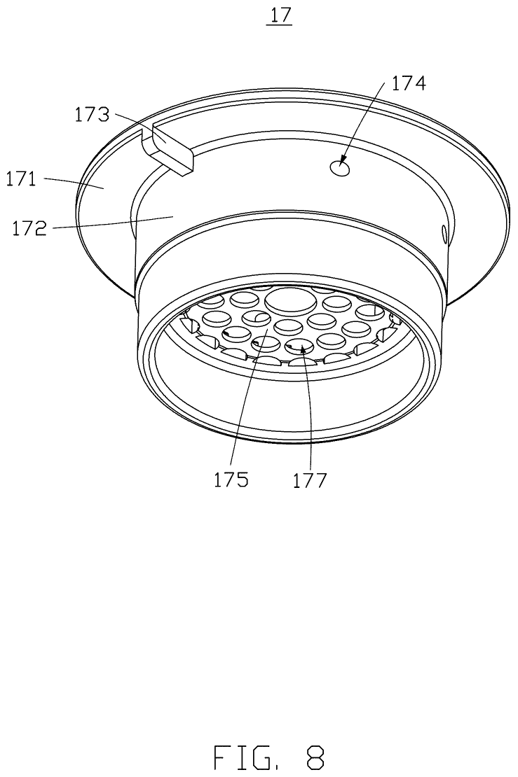

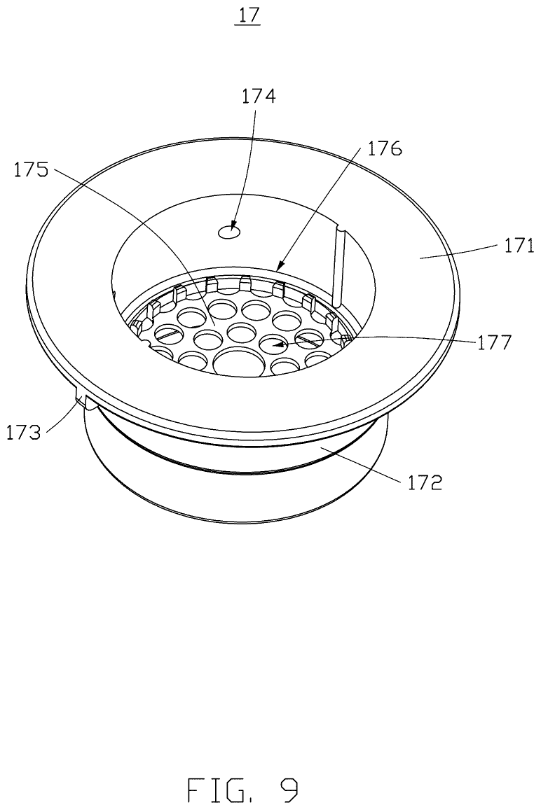

FIG. 8 and FIG. 9 illustrate a supporting member 17 in accordance with an embodiment of the present application.

The supporting member 17 includes a second step portion 171, a main body portion 172, and a filter portion 175.

In one embodiment, the second step portion 171, the main body portion 172 and the filter portion 175 are all made of same material. Optionally, the second step portion 171, the main body portion 172 and the filter portion 175 may all be made of metal.

The main body portion 172 is fixedly connected to the second step portion 171. The second step portion 171 can surround one end of the main body portion 172 of the supporting member 17 and extend outward from the end of the main body portion 172 perpendicular to the main body portion 172 to form a circular structure. Both the main body portion 172 and the second step portion 171 are hollow structures, and the through groove 176 can be defined on the inside of the main body portion 172 and the inside of the second step portion 171. The filter portion 175 is disposed in the through groove 176, the filter portion 175 is connected to the inner side of the main body portion 172, the outer edge of the filter portion 175 is in a circular shape and connected to the through groove 176. The filter portion 175 defines a plurality of filter holes 177, and the plurality of filter holes 177 is used to prevent small impurities from being sucked into the interior of the vacuumizing device. Therefore, the vacuumizing assembly 10 can first filter larger impurities through the mesh portion 12, and then filter smaller impurities through the filter portion 175, thereby preventing impurities of different shapes from being sucked into the interior of the vacuumizing device and playing a double filtering role.

In one embodiment, the main body portion 172 of the supporting member 17 defines at least one second through hole 174, and the number of the second through holes 174 can be set according to actual needs. This embodiment takes four second through holes 174 on the main body portion 172 of the supporting member 17 as an example for explanation. The four second through holes 174 are evenly distributed in the 0 degree direction, 90 degree direction, 180 degree direction, and 270 degree direction of the main body portion 172.

The four second through holes 174 on the main body portion 172 of the supporting member 17 correspond one-to-one with the four first through holes 132 on the base portion 131 of the suction nozzle 11. Therefore, the present application can achieve the connection between the main body portion 172 of the supporting member 17 and the connecting portion 13 of the suction nozzle 11 by threading screws through the corresponding first through hole 132 and the corresponding second through hole 174, respectively.

In one embodiment, the main body portion 172 of the supporting member 17 can be sleeved within the hollow pipe 15 of the suction nozzle 11. In another embodiment, an outer side of the main body portion 172 of the supporting member 17 can be sleeved with an inner side of the hollow pipe 15 of the suction nozzle 11.

One side of the second step portion 171 of the supporting member 17 near the connecting portion 13 is provided with at least one resisting block 173. The number of resisting blocks 173 of the supporting member 17 can be equal to the number of receiving portions 133, and the number of resisting blocks 173 and the number of receiving portions 133 can be set according to the actual needs. This embodiment takes two resisting blocks 173 as an example for explanation.

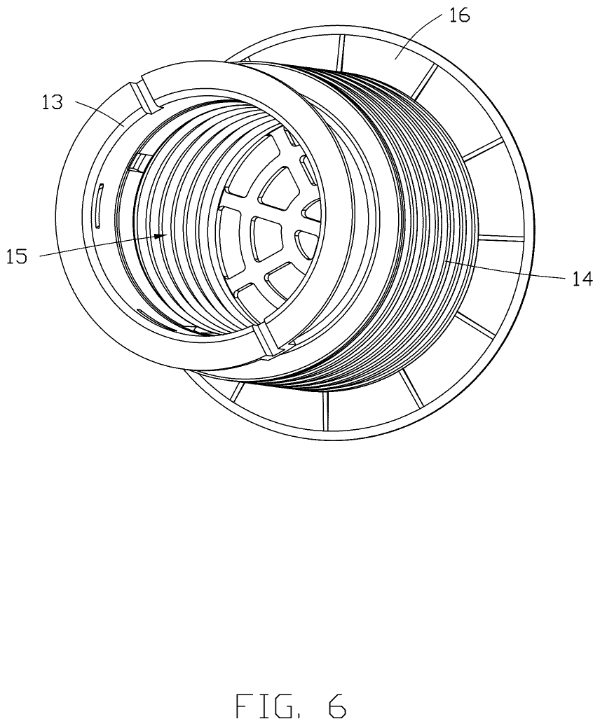

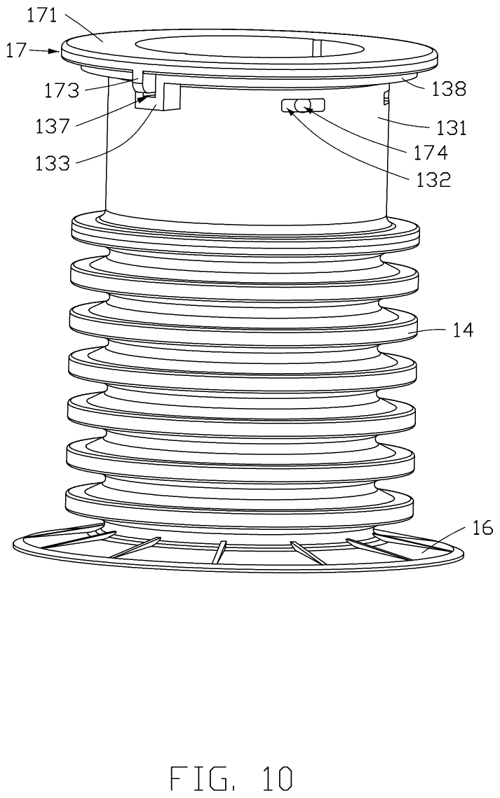

As shown in FIG. 10, when the connecting portion 13 (as shown in FIG. 6 and FIG. 7) of the suction nozzle 11 is connected to the supporting member 17 (as shown in FIG. 8 and FIG. 9), the main body portion 172 of the supporting member 17 can be sleeved into the hollow pipe 15 of the suction nozzle 11, the through groove 176 of the supporting member 17 can be communicated with the hollow pipe 15 of the suction nozzle suction nozzle 11, and the position of the second through hole 174 corresponds to the position of the first through hole 132, the second step portion 171 is held against the first step portion 138, and the two resisting blocks 173 of the second step portion 171 correspond one-to-one with the two notches 137 on the first step portion 138, and the two resisting blocks 173 of the second step portion 171 can be respectively snapped within the two notches 137 on the first step portion 138, so as to limit the rotation of the supporting member 17 relative to the connecting portion 13, so that the connection between the connecting portion 13 and the supporting member 17 is more secure.

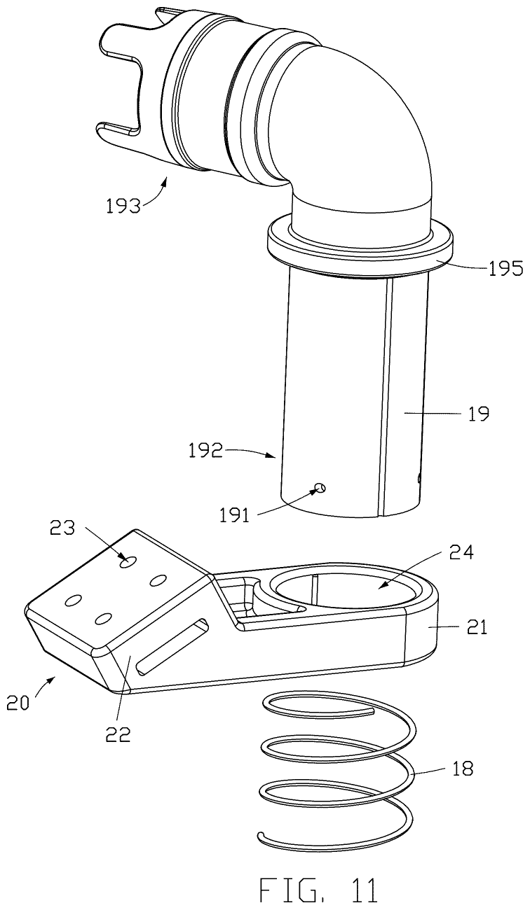

Referring to FIG. 11 and FIG. 12, the trachea 19 includes a first end 192 and a second end 193. The first end 192 of the trachea 19 can be sleeved into the through groove 176 of the supporting member 17. The second end 193 of the trachea 19 can be connected to a vacuum pressure source 500 (as shown in FIG. 14). In one embodiment, the inner side of the trachea 19 has a pipeline 194 (as shown in FIG. 5), when the connecting portion 13 is sleeved with the supporting member 17 and the first end 192 of the trachea 19 is sleeved into the through groove 176 of the supporting member 17, the pipeline 194 of the trachea 19 can be communicated with the hollow pipe 15 of the suction nozzle 11. Therefore, the vacuum pressure source 500 can be used to realize the vacuum extraction and release through the pipeline 194 and the hollow pipe 15, to realize picking and placing of the object.

The first end 192 of the trachea 19 defines at least one first screw hole 191, and the number of the first screw hole 191 can be set according to actual needs. This embodiment takes four first screw holes 191 as an example for explanation. The four first screw holes 191 of the trachea 19 correspond one-to-one with the four second through holes 174 on the supporting member 17 and the four first through holes 132 on the suction nozzle 11, so that the screw can pass through the first through hole 132 of the connecting portion 13 and the second through hole 174 of the supporting member 17 sequentially and then be locked into the first screw holes 191 of the trachea 19, thereby realizing the connection between the connecting portion 13, the supporting member 17 and the trachea 19.

The fixing structure 20 includes a sleeve portion 21 and a fixing portion 22, one end of the sleeve portion 21 is fixedly connected to the fixing portion 22, and another end of the sleeve portion 21 defines an annular groove 24. It can be understood that the first end 192 of the trachea 19 can pass through the annular groove 24 of the sleeve portion 21, so that the sleeve portion 21 of the fixing structure 20 can be sleeved on the outer side of the trachea 19.

The outer side of the trachea 19 is also provided with a resisting portion 195, the resisting portion 195 can extend outward from the outer side of the trachea 19, the resisting portion 195 can surround the central position of the trachea 19. When the elastic element 18 is sleeved on the outer side of the trachea 19, the resisting portion 195 is held against one end of the elastic element 18.

The fixing portion 22 is connected to the machine arm 200. The fixing portion 22 defines at least one second screw hole 23, and the present application uses a screw (not shown in the figure) to pass through the through hole on the machine arm 200 and the screw can be locked in the second screw hole 23 on the fixing portion 22, thereby realizing the connection between the machine arm 200 and the fixing structure 20,

The elastic element 18 is sleeved on the outer side of the trachea 19, the sleeve portion 21 of the fixing structure 20 is held against between the elastic element 18 and the resisting portion 195. The elastic element 18 can be used to buffer the impact force on the machine arm 200 or the vacuumizing device 100, thereby extending the service life of the vacuumizing device 100. In one embodiment, the elastic element 18 can be a spring.

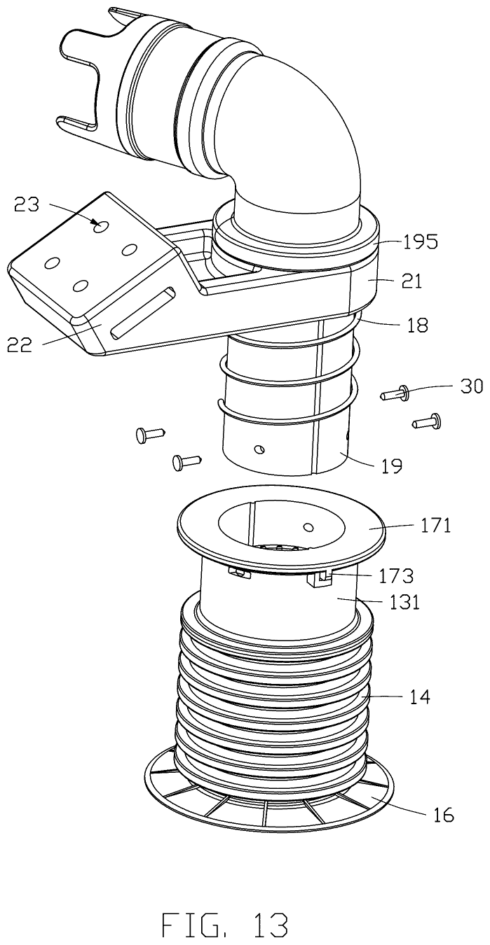

Referring to FIG. 13, when the trachea 19 is connected to the supporting member 17, at least a part of the trachea 19 will be sleeved into the through groove 176 of the supporting member 17, and the hollow pipe 15, the through groove 176, and the pipeline 194 of the trachea 19 can be communicated with each other. The two ends of the elastic element 18 are respectively held against the sleeve portion 21 of the fixing structure 20 and the second step portion 171 of the supporting member 17, the screw 30 can sequentially pass through the second through hole 174 of the main body portion 172 and the first through hole 132 of the base portion 131, and is locked in the first screw hole 191 of the trachea 19, thereby connecting the trachea 19, the supporting member 17, and the connecting portion 13 together.

FIG. 14 illustrates a system 1000 in accordance with an embodiment of the present application. The system 1000 is used to pick and place the objects.

The system 1000 includes at least the following parts: a vacuumizing device 100, a machine arm 200, an operating and controlling unit 300, a power supply device 400, a vacuum pressure source 500, a vacuum pressure sensor 600, a memory 700, and a foreign object remover 800.

The power supply device 400 is electrically connected to the operating and controlling unit 300, and the power supply device 400 can be used to supply power to the operating and controlling unit 300. The vacuumizing device 100 is fixed to the machine arm 200 through the fixing structure 20. The operating and controlling unit 300 is connected to the machine arm 200, and the operating and controlling unit 300 can be used to control the machine arm 200 to move and thus drive the vacuumizing device 100 to move. The vacuum pressure source 500 is connected to the vacuumizing device 100. The second end 193 of the trachea 19 is connected to the vacuum pressure source 500 (as shown in FIG. 14), and the hollow pipe 15, the through groove 176, the pipeline 194 of the trachea 19 are communicated with each other, so as to pick and place the object.

When the system 1000 needs to pick up the object, the operating and controlling unit 300 controls the machine arm 200 to move to drive the vacuumizing device 100 to the position of the object and realizes the picking up of the object by the control of the vacuum pressure source 500.

In one embodiment, the vacuum pressure sensor 600 is connected to the operating and controlling unit 300. The vacuum pressure sensor 600 can be disposed inside the hollow pipe 15 of the vacuumizing device 100 to sense the vacuum pressure value inside the hollow pipeline of the vacuumizing device 100 and feedback the sensed vacuum pressure value to the operating and controlling unit 300.

In one embodiment, when the operating and controlling unit 300 detects the vacuum pressure value through the vacuum pressure sensor 600 and determines that the vacuumizing device 100 has sucked the foreign objects, the operating and controlling unit 300 can control the machine arm 200 to move to the foreign object remover 800 to remove the foreign objects sucked up by the vacuumizing device 100 through the foreign object remover 800.

In one embodiment, the operating and controlling unit 300 can be a central processing unit (CPU), digital signal processing (DSP), application specific integrated circuit (ASIC), field programmable gate array (FPGA), or other programmable logic device, discrete gate or transistor logic device, discrete hardware components, without limitation of the embodiments of the present application, and in some other possible implementations, the above operating and controlling unit 300 can also be a control circuit composed of a plurality of switching tubes or a plurality of transistors.

The machine arm 200 is communicatively connected to the operating and controlling unit 300. For example, the machine arm 200 can be connected to the operating and controlling unit 300 by means of wireless communication technology, and the machine arm 200 can also be connected to the operating and controlling unit 300 by means of wire transmission communication technology to realize the transmission of control commands between the operating and controlling unit 300 and the machine arm 200.

In one embodiment, the memory 700 can store computer programs, and the operating and controlling unit 300 can control other components by accessing the computer programs in the memory 700.

FIG. 15 is a schematic diagram of the system 1000 provided in an embodiment of the present application for replacing the suction nozzle 11.

As shown in FIG. 15, one end of the fixing structure 20 is sleeved with the trachea 19 of the vacuumizing assembly 10, and another end of the fixing structure 20 is detachably connected to the machine arm 200. The machine arm 200 drives the vacuumizing assembly 10 to move according to the instructions of the operating and controlling unit 300.

In another possible scenario, when the suction nozzle 11 of the vacuumizing assembly 10 is blocked by a foreign object, the suction nozzle 11 needs to remove the foreign object. Therefore, the system 1000 can apply a foreign object remover 800 to remove the foreign object sucked up by the suction nozzle 11.

The foreign object remover 800 includes a first connecting plate 801 and a second connecting plate 802. One end of the first connecting plate 801 is fixedly connected to one end of the second connecting plate 802. Optionally, one end of the first connecting plate 801 is vertically connected to one end of the second connecting plate 802. One side of the second connecting plate 802 extends to a mounting plate 803, and the mounting plate 803 defines a mounting hole 804. In other words, the foreign object remover 800 can be installed in a fixed position through the mounting plate 803. Optionally, the mounting plate 803 can be vertically connected to one side of the second connecting plate 802.

The first connecting plate 801 defines a slot 805. When the suction nozzle 11 sucks up a foreign object (such as an iron cap or a plastic bag), the operating and controlling unit 300 can control the movement of the machine arm 200 to drive the vacuumizing assembly 10 to the groove position of the foreign object remover 800 and remove the foreign object on the suction nozzle 11 through the first connecting plate 801, achieving automatic removal of foreign objects on the suction nozzle 11, thereby avoiding the suction nozzle 11 from being blocked.

In a possible scenario, when the suction nozzle 11 of the vacuumizing assembly 10 sucks up more impurities and results in lower efficiency, or when the suction nozzle 11 develops a broken condition, the suction nozzle 11 needs to be replaced in a timely manner. Based on such a scenario, the operating and controlling unit 300 will control the machine arm 200 to move to the position of the suction nozzle replacement subsystem, so as to perform the replacement of the suction nozzle 11.

In a specific implementation, the system 1000 can further include a first suction nozzle replacement device 901 and a second suction nozzle replacement device 902. The second suction nozzle replacement device 902 is provides with an unused suction nozzle 11 that combines with the supporting member 17. When the vacuumizing assembly 10 is necessary to replace the suction nozzle 11, the operating and controlling unit 300 will control the movement of the machine arm 200 to place the vacuumizing assembly 10 in a receiving space of the first suction nozzle replacement device 901.

The present application uses the first suction nozzle replacement device 901 to remove the suction nozzle 11 combined with the supporting member 17 from the vacuumizing assembly 10. In one embodiment, the suction nozzle 11 combined with the supporting member 17 in the vacuumizing assembly 10 is first positioned in the first suction nozzle replacement device 901 and secured, and then the screw 30 is removed from the second through hole 174 on the main body portion 172, the first through hole 132 on the base portion 131, and the first screw hole 191 of the trachea 19, and then the suction nozzle 11 combined with the supporting member 17 and the machine arm 200 are separated after the machine arm 200 is moved upwardly (as shown in FIG. 13).

In one embodiment, the operating and controlling unit 300 will control the movement of the machine arm 200, which has removed the suction nozzle 11 (shown in FIG. 12) combined with the supporting member 17, to be positioned in the second suction nozzle replacement device 902. The second suction nozzle replacement device 902 receives the unused suction nozzle 11 combined with supporting member 17, and the suction nozzle 11 combined with supporting member 17 in the vacuumizing assembly 10 is positioned in the second suction nozzle replacement device 902 and fixed in the second suction nozzle replacement device 902. The machine arm 200 moves to be positioned in the second suction nozzle replacement device 902, the screw 30 aligns the second through hole 174 of the supporting member 17, the first through hole 132 of the connecting portion 13, and the first screw hole 191 of the trachea 19 to be connected to the machine arm 200, and the suction nozzle 11 and the machine arm 200 complete the replacement and completes the automatic replacement of the suction nozzle 11.

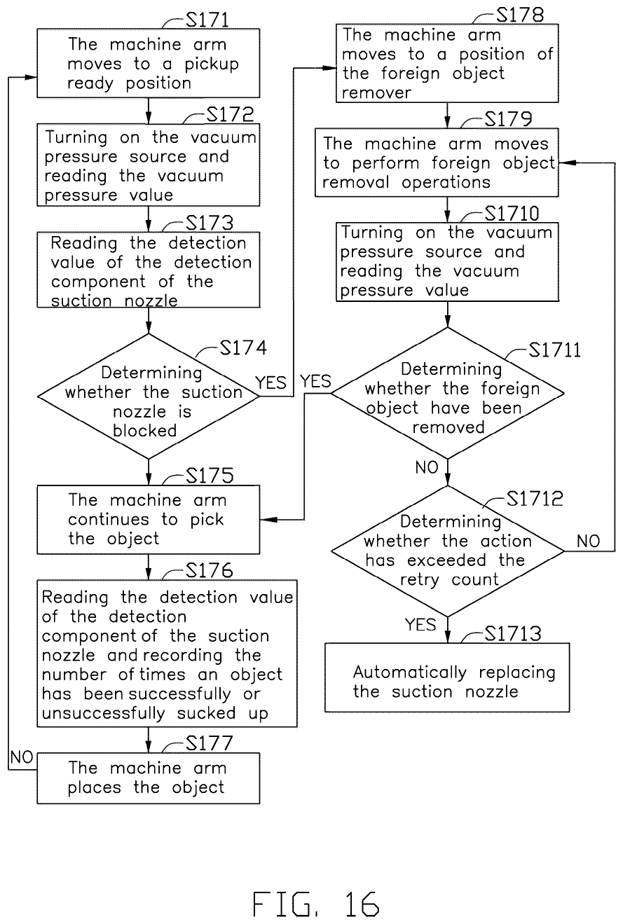

FIG. 16 is a flowchart of a method for picking and placing objects in accordance with an embodiment of the present application. The method includes the following steps:

At step S171, the machine arm moves to a pickup ready position.

More specifically, the machine arm 200 may move to the pickup ready position in response to an instruction of the operating and controlling unit 300.

At step S172, turning on the vacuum pressure source and reading the vacuum pressure value.

More specifically, after the vacuum pressure source 500 is turned on, the operating and controlling unit 300 can read the vacuum pressure value inside the hollow pipe of the vacuumizing device 100 through the vacuum pressure sensor 600.

At step S173, reading the detection value of the detection component of the suction nozzle.

More specifically, the operating and controlling unit 300 will also read the detection value of the detection component (e.g., the flexible pressure sensor 40 shown in FIG. 2). component

At step S174, determining whether the suction nozzle is blocked. If the suction nozzle is blocked, step S178 is implemented, otherwise, step S175 is implemented.

At step S175, the machine arm continues to pick the object.

More specifically, when the suction nozzle 11 is not blocked, the operating and controlling unit 300 can control the machine arm 200 to continue the object picking action.

At step S176, reading the detection value of the detection component of the suction nozzle and recording the number of times an object has been successfully or unsuccessfully sucked up.

More specifically, the operating and controlling unit 300, while controlling the machine arm 200 to continue the object picking action, may also read the detection value of the detection component (e.g., the flexible pressure sensor 40 shown in FIG. 2) of the suction nozzle 11, so that it may be possible to determine, by means of the detection value of the flexible pressure sensor 40, whether or not the suction nozzle 11 has succeeded in picking up the object. In addition, the operating and controlling unit 300 will record the number of times the object has been successfully or unsuccessfully sucked up.

At step S177, the machine arm places the object.

More specifically, the operating and controlling unit 300 controls the machine arm 200 to perform the object placing action.

At step S178, the machine arm moves to a position of the foreign object remover.

More specifically, when the operating and controlling unit 300 determines that the suction nozzle 11 is blocked, the operating and controlling unit 300 controls the machine arm 200 to move to the position of the foreign object remover 800.

At step S179, the machine arm moves to perform foreign object removal operations.

The operating and controlling unit 300 controls the movement of the machine arm 200 to perform the foreign object removal action. As shown in FIG. 5, the operating and controlling unit 300 can control the movement of the machine arm 200 to move the vacuumizing assembly 10 to the groove position of the foreign object remover 800 and remove the foreign objects on the suction nozzle 11 through the first connecting plate 801, so as to realize the automatic removal of the foreign object from the suction nozzle 11 to prevent the suction nozzle 11 from being blocked.

At step S1710, turning on the vacuum pressure source and reading the vacuum pressure value.

More specifically, the operating and controlling unit 300 can read the vacuum pressure value inside the hollow pipe of the vacuumizing device 100 through the vacuum pressure sensor 600 to determine whether the foreign object is removed or not.

At step S1711, determining whether the foreign object have been removed. If the foreign object have been removed, step S175 is implemented, otherwise, step S1712 is implemented.

If the operating and controlling unit 300 determines that the foreign object has been removed, the operating and controlling unit 300 controls the machine arm 200 to continue the object placing action.

At step S1712, determining whether the action has exceeded the retry count. If the action has exceeded the retry count, step S1713 is implemented, otherwise, returns to step S179.

At step S1713, automatically replacing the suction nozzle.

If the foreign object cannot be removed, the suction nozzle is replaced, and the specific realization process can be referred to the description of the replacement of the suction nozzle in FIG. and will not be repeated here.

Based on the above embodiments of the present application, the present application can detect whether there is a foreign object blocked in the suction nozzle 11, and it can also realize the rapid replacement of the suction nozzle, which improves the working efficiency of the system.

Even though numerous characteristics and advantages of the present technology have been set forth in the foregoing description, together with details of the structure and function of the present application, the application is illustrative only, and changes can be made in the detail, especially in matters of shape, size, and arrangement of the parts within the principles of the present application, up to and including the full extent established by the broad general meaning of the terms used in the claims. It will, therefore, be appreciated that the exemplary embodiments described above can be modified within the scope of the claims.

What is claimed is:

1. A vacuumizing assembly comprising:
a suction nozzle comprising:
a mesh portion disposed at a first end of the suction nozzle,
a connecting portion disposed at a second end of the suction nozzle and the first end disposed opposite to the second end, and
a telescopic portion disposed between the first end and the second end, and the telescopic portion configured for extending or contracting between the first end and the second end,
wherein an inner side of the telescopic portion and an inner side of the connecting portion form a hollow pipeline of the suction nozzle.

2. The vacuumizing assembly according to claim 1, wherein the suction nozzle further comprises a cover body portion, the cover body portion surrounds the first end and extends outward from the first end, and the cover body portion, the telescopic portion and the mesh portion are made of same material.

3. The vacuumizing assembly according to claim 1, further comprising a supporting member, wherein the connecting portion is socketed on the supporting member, the support member comprising a main body portion and a plurality of filter holes, the main body portion defines a through groove, and the plurality of filter holes are disposed in the through groove.

4. The vacuumizing assembly according to claim 3, further comprising a trachea, wherein the trachea is connected to the suction nozzle through the supporting member.

5. The vacuumizing assembly according to claim 4, further comprising an elastic element, wherein the elastic element is sleeved on the trachea.

6. The vacuumizing assembly according to claim 4, wherein an inner side of the trachea is provided with a pipeline, and the pipeline is communicated with the hollow pipe of the suction nozzle.

7. A vacuumizing assembly comprising:
a suction nozzle comprising:
a mesh portion disposed at a first end of the suction nozzle,
a connecting portion disposed at a second end of the suction nozzle and the first end disposed opposite to the second end, and
a telescopic portion disposed between the first end and the second end, and the telescopic portion configured for extending or contracting between the first end and the second end, wherein an inner side of the telescopic portion and an inner side of the connecting portion form a hollow pipeline of the suction nozzle,
a detection component configured to detect whether the telescopic portion has a preset deformation.

8. The vacuumizing assembly according to claim 7, wherein the suction nozzle further comprises a cover body portion, the cover body portion surrounds the first end and extends outward from the first end, and the cover body portion, the telescopic portion, and the mesh portion are made of same material.

9. The vacuumizing assembly according to claim 7, further comprising a supporting member, wherein the connecting portion is socketed on the supporting member, the support member comprising a main body portion and a plurality of filter holes, the main body portion defines a through groove, and the plurality of filter holes are disposed in the through groove.

10. The vacuumizing assembly according to claim 7, wherein the detection component is a flexible pressure sensor.

11. The vacuumizing assembly according to claim 10, wherein the flexible pressure sensor is disposed at the telescopic portion.

12. The vacuumizing assembly according to claim 9, further comprising a trachea, wherein the trachea is connected to the suction nozzle through the supporting member.

13. The vacuumizing assembly according to claim 12, further comprising an elastic element, wherein the elastic element is sleeved on the trachea.

14. The vacuumizing assembly according to claim 12, wherein an inner side of the trachea is provided with a pipeline, and the pipeline is communicated with the hollow pipe of the suction nozzle.

15. A vacuumizing device comprising:
a vacuumizing assembly comprising:
a suction nozzle comprising:
a mesh portion disposed at a first end of the suction nozzle,
a connecting portion disposed at a second end of the suction nozzle and the first end disposed opposite to the second end,
a telescopic portion disposed between the first end and the second end, and the telescopic portion configured for extending or contracting between the first end and the second end, wherein an inner side of the telescopic portion and an inner side of the connecting portion form a hollow pipeline of the suction nozzle, and
a detection component configured to detect whether the telescopic portion has a preset deformation,
a fixing structure, one end of the fixing structure is sleeved on a trachea, and another end of the fixing structure is detachably connected to a machine arm.

16. The vacuumizing device according to claim 15, wherein the suction nozzle further comprises a cover body portion, the cover body portion surrounds the first end and extends outward from the first end, and the cover body portion, the telescopic portion, and the mesh portion are made of same material.

17. The vacuumizing device according to claim 15, wherein vacuumizing assembly further comprises a supporting member, the connecting portion is socketed on the supporting member, the support member comprising a main body portion and a plurality of filter holes, the main body portion defines a through groove, and the plurality of filter holes are disposed in the through groove.

18. The vacuumizing device according to claim 15, wherein the detection component is a flexible pressure sensor.

19. The vacuumizing device according to claim 18, wherein the flexible pressure sensor is disposed at the telescopic portion.

20. The vacuumizing assembly according to claim 17, further comprising a trachea, wherein the trachea is connected to the suction nozzle through the supporting member.
